(19) United States
(12) Patent Application Publication
(10) Pub. No.: US 2021/0241119 A1
(43) Pub. Date: Aug. 5, 2021

(54) PRE-TRAINED MODEL UPDATE DEVICE, PRE-TRAINED MODEL UPDATE METHOD, AND PROGRAM

(71) Applicant: NEC Corporation, Minato-ku, Tokyo (JP)

(72) Inventors: Tsubasa TAKAHASHI, Tokyo (JP); Kazuya KAKIZAKI, Tokyo (JP)

(73) Assignee: NEC Corporation, Minato-ku, Tokyo (JP)

(21) Appl. No.: 17/050,583

(22) PCT Filed: Apr. 27, 2018
(86) PCT No.: PCT/JP2018/017220

§ 371 Date: Oct. 26, 2020

(51) Int. Cl. G06N 3/08; G06N 3/04

(52) U.S. Cl. CPC G06N 3/088; G06N 3/0454

(57) ABSTRACT

A pre-trained model update device includes: an alternative example generation unit configured to generate an alternative example and a correct answer label corresponding to the alternative example, based on a generative model representing training data used in generating a pre-trained model; an adversarial example generation unit configured to generate an adversarial example inducing the pre-trained model to misclassify and a correction label corresponding to the adversarial example, based on an attack model and based on the alternative example and the correct answer label generated by the alternative example generation unit; and a model update unit configured to perform additional learning based on a result of generation by the alternative example generation unit and a result of generation by the adversarial example generation unit, and generate an updated model.

### TECHNICAL FIELD

The present invention relates to a pre-trained model update device, a pre-trained model update method, and a program.

### BACKGROUND ART

A technique called machine learning is known, which is learning a huge amount of training data and building a model. Vulnerability can be a problem in a pre-trained model built by such machine learning. For example, in a pre-trained model as mentioned above, the use of an adversarial example (AX) may induce a malfunction that is not anticipated by the designer at the time of training.

As a countermeasure for the problem caused by an adversarial example, adversarial training is performed, which is supervised learning of a classifier using data including a normal example and correct answer label pair and additionally an adversarial example and correction label pair as training data is performed. However, the method using adversarial training has a problem that an adversarial example may be unavailable due to a reason such as being unknown when a classifier is built, and a problem that resistance to a future attack is not acquired only with an adversarial example obtained when a classifier is built. In addition, for example, in a case where it is desired to evaluate performance on clean normal examples, execution of adversarial training with an adversarial example being mixed from the beginning may disable grasping the degree of classification accuracy of building a classifier using normal examples.

As described above, the method using adversarial training has a plurality of problems. Then, it is considered to be necessary to, instead of taking measures that give resistance to an adversarial example when building a classifier as in adversarial training, perform additional learning (an update process) that incrementally gives resistance to an attack to be dealt with on the parameter of a pre-trained model after occurrence of the attack. One of such techniques is shown in, for example, Non-Patent document. For example, Non-Patent Document 1 refers to delaying adversarial training in which both normal examples and adversarial examples are prepared at the time of training, learning a classification task using only the clean normal examples is firstly performed, and then learning a classification task using both the normal examples and the adversarial examples and having resistance to the adversarial examples is performed. This delaying adversarial training is the same concept as the abovementioned additional learning.

Further, a related technique is shown in, for example, Patent Document 1. Patent Document 1 describes a case of using AAE (Adversarial AutoEncoder) as a model of machine learning. According to Patent Document 1, in the case of using AAE, in addition to learning an encoder and a decoder, learning a discriminator is performed. Learning a discriminator is performed using training data that is normal data.
Patent Document 1: WO2017/094267
Non-Patent Document 1: Alexey Kurakin, Ian J. Goodfellow, Samy Bengio. “Adversarial Machine Learning at Scale”, Proceedings of 5th International Conference on Learning Representations (ICLR2017), 2017.
Non-Patent Document 2: Sang-Woo Lee, Jin-Hwa Kim, Jaehyun Jun, Jung-Woo Ha, and Byoung-Tak Zhang. “Overcoming Catastrophic Forgetting by Incremental Moment Matching”, Proceedings of 31st Conference on Neural Information Processing Systems (NIPS2017), 2017.

When only adversarial examples are used as training data at the time of performing additional learning using adversarial examples, a learning effect by normal examples used in the original training data may be diminished or lost, that is, forgetting may occur. In order to avoid forgetting, it is desirable to include not only adversarial examples but also normal examples (normal data) in training data as described in Non-Patent Document 1 and Patent Document 1.

However, the size of normal examples may exceed several TB when it is large and, if the normal examples are stored in anticipation of future updates, disk capacity necessary for storage and the cost of server operation and so on will be required. In addition, since the size of the data is large, there is also a problem that it is difficult to transmit to a place where the pre-trained model is being operated. Thus, although it is desirable to use not only adversarial examples but also normal examples in order to avoid forgetting, normal examples are large in size and hence the cost required for storage is high, and consequently, there has been a problem that it may become difficult to update the pre-trained model.

### SUMMARY

Accordingly, an object of the present invention is to provide a pre-trained model update device, a pre-trained model update method and a program which solve a problem that it may become difficult to update a pre-trained model with forgetting being inhibited.

In order to achieve the object, a pre-trained model update device according to an aspect of the present invention includes: an alternative example generation unit configured to generate an alternative example and a correct answer label corresponding to the alternative example, based on a generative model representing training data used in generating a pre-trained model; an adversarial example generation unit configured to generate an adversarial example inducing the pre-trained model to misclassify and a correction label corresponding to the adversarial example, based on an attack model and based on the alternative example and the correct answer label generated by the alternative example generation unit; and a model update unit configured to perform additional learning based on a result of generation by the alternative example generation unit and a result of generation by the adversarial example generation unit, and generate an updated model.

Further, a pre-trained model update method according to another aspect of the present invention is executed by a pre-trained model update device. The method includes: generating an alternative example and a correct answer label corresponding to the alternative example, based on a generative model representing training data used in generating a pre-trained model; generating an adversarial example inducing the pre-trained model to misclassify and a correction label corresponding to the adversarial example, based on an attack model and based on the alternative example and the correct answer label generated by the alternative example generation unit; and performing additional learning based on the alternative example and the correct answer label and based on the adversarial example and the correction label, and generating an updated model.

Further, a program according to another aspect of the present invention is a computer program comprising instructions for causing a pre-trained model update device to realize: an alternative example generation unit configured to generate an alternative example and a correct answer label corresponding to the alternative example, based on a generative model representing training data used in generating a pre-trained model; an adversarial example generation unit configured to generate an adversarial example inducing the pre-trained model to misclassify and a correction label corresponding to the adversarial example, based on an attack model and based on the alternative example and the correct answer label generated by the alternative example generation unit; and a model update unit configured to perform additional learning based on a result of generation by the alternative example generation unit and a result of generation by the adversarial example generation unit, and generate an updated model.

With the configurations as described above, the present invention can provide a pre-trained model update device, a pre-trained model update method and a program which solve the problem that it may become difficult to update a pre-trained model with forgetting being inhibited.

### BRIEF DESCRIPTION OF DRAWINGS

FIG. 1 is a block diagram showing an example of a configuration of an update device in a first example embodiment of the present invention;

FIG. 2 is a view showing an example of generation of an adversarial example;

FIG. 3 is a view showing an example of processing by a model update unit;

FIG. 4 is a flowchart showing an example of processing by the update device;

FIG. 5 is a block diagram showing an example of another configuration of the update device;

FIG. 6 is a block diagram showing an example of another configuration of the update device;

FIG. 7 is a block diagram showing an example of a configuration of an update device in a second example embodiment of the present invention;

FIG. 8 is a view exemplifying a hardware configuration of a computer (an information processing device) which can realize the first example embodiment and the second example embodiment of the present invention; and

FIG. 9 is a block diagram showing an example of a configuration of a pre-trained model update device in a third example embodiment of the present invention.

### EXEMPLARY EMBODIMENTS

### First Example Embodiment

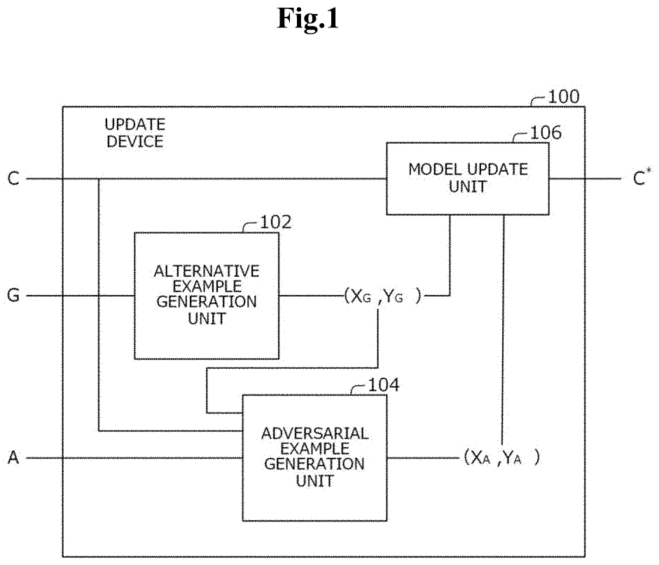

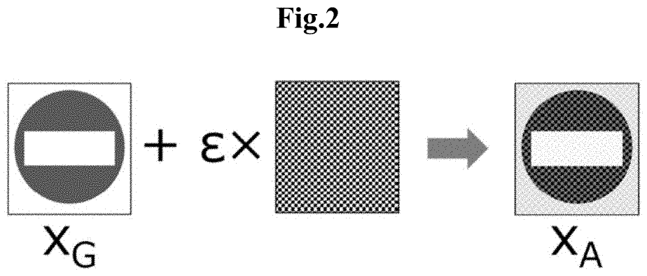

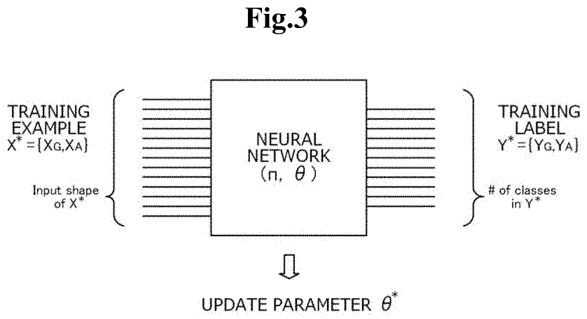

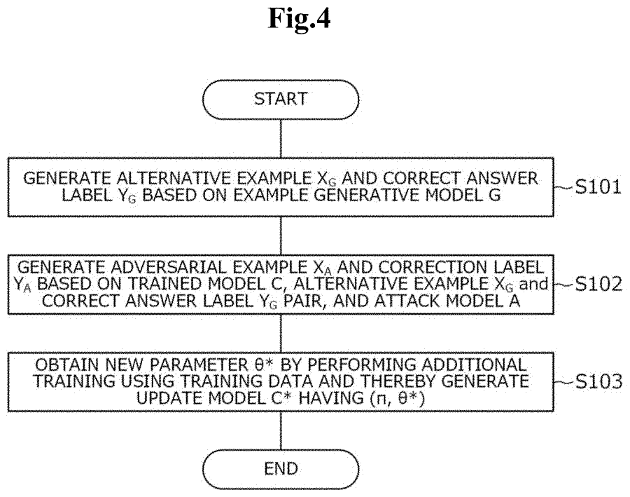

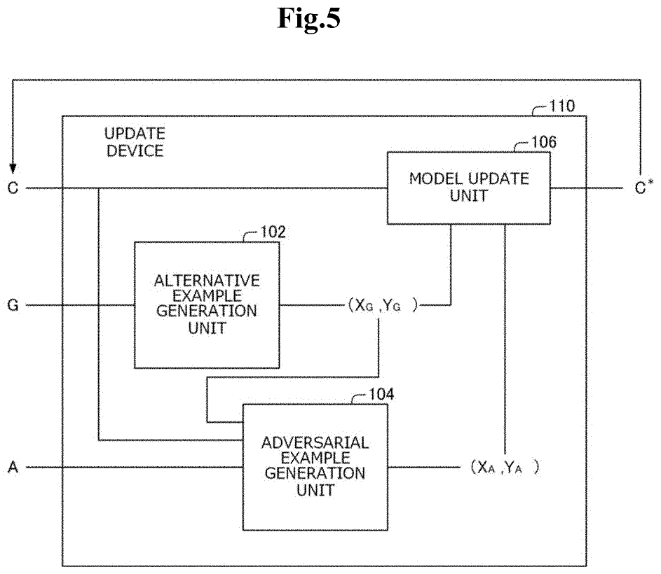

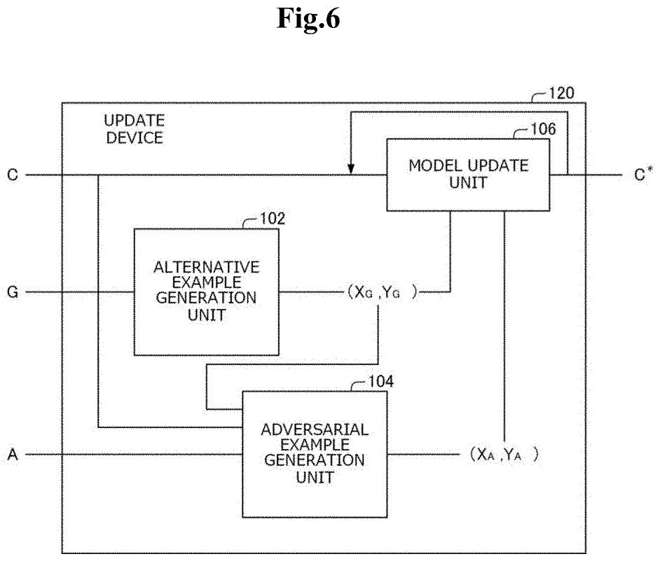

A first example embodiment of the present invention will be described with reference to FIGS. 1 to 6. FIG. 1 is a block diagram showing an example of a configuration of an update device 100. FIG. 2 is a view showing an example of generation of an adversarial example in an adversarial example generation unit 104. FIG. 3 is a view showing an example of processing by a model update unit 106. FIG. 4 is a flowchart showing an example of processing by the update device 100. FIG. 5 is a block diagram showing an example of a configuration of an update device 100. FIG. 6 is a block diagram showing an example of a configuration of an update device 120.

In the first example embodiment of the present invention, the update device 100 (a pre-trained model update device) that updates a pre-trained model C will be described. As will be described later, the update device 100 generates an alternative example X_{G} and a correct answer label Y_{G} based on an example generative model G. The update device 100 also generates an adversarial example X_{A} and a correction label Y_{G} based on an attack model A. Then, with alternative example and correct model pairs (X_{G}, Y_{G}) and adversarial example (AX) and correction label pairs (X_{A}, Y_{A}) as training data, the update device 100 performs additional training on a neural network 7E and parameter θ of the pre-trained model C and thereby obtains a new parameter θ*. With this, the update device 100 generates an updated model C* having (π, θ*).

The update device 100 generates the updated model C* by performing additional learning on the pre-trained model C. For example, the pre-trained model C, the example generative model G, and the attack model A are input in the update device 100.

The pre-trained model C is a model generated in advance by machine learning with normal example X_{L} and correct answer label Y_{L} pairs as training data. The pre-trained model C may be a model obtained by adversarial training, that is, a model generated by machine learning with adversarial example and correction label pairs being included in training data. For example, the pre-trained model C includes a neural network structure 7E and a parameter θ. In the pre-trained model C, the parameter θ may be expressed with a neural network structure being included.

The example generative model G is a model generated in advance by using a method of learning so as to represent a generative model of training data corresponding to a training label with a small number of parameters, such as Conditional Generative Adversarial Networks (CGAN), a succeeding or developed form of CGAN like Auxiliary Classifier GAN (ACGAN), and Conditional Variational Auto Encoder (CVAE). In other words, the example generative model G is a model generated in advance based on normal example X_{L} and correct answer label Y_{L} pairs representing the training data used at the time of generating the pre-trained model C. For example, as will be described later, the example generative model G can generate an alternative example x_{G} and correct answer label y_{G} pair by specifying a data point on the example generative model G using a random number r.

The attack model A is a model capable of generating an adversarial example, such as Fast Gradient Sign Method (FGSM), Carlini-Wagner L2 Attack (CW Attack), Deepfool, and Iterative Gradient Sign Method. For example, as will be described later, the attack model A can perform a predetermined calculation and thereby generate the adversarial example X_{A} having a perturbation (deviation) from the alternative example X_{G}.

For example, the pre-trained model C, the example generative model G and the attack model A as described above are input into the update device 100. The update device 100 has a storage unit such as a hard disk or a memory (not shown), and one or more of the models described above may be previously stored in the storage unit.

FIG. 1 shows an example of the configuration of the update device 100. Referring to FIG. 1, the update device 100 includes an alternative example generation unit 102, an adversarial example generation unit 104, and a model update unit 106.

For example, the update device 100 has a storage unit and an arithmetic logic unit, which are not shown. The update device 100 realizes the abovementioned processing units by the arithmetic logic unit executing a program stored in the storage unit (not shown).

In this example embodiment, it is assumed that normal examples x_{L}∈normal examples X_{L}, alternative examples x_{G}∈alternative examples X_{G}, and adversarial examples x_{A}∈adversarial examples X_{A}. It is also assumed that the dimensions of the respective examples are identical.

The alternative example generation unit 102 generates the alternative example X_{G} and the correct answer label Y_{G} for the alternative example X_{G} based on the example generative model G having been input therein.

For example, it is assumed that the example generative model G is composed by the abovementioned CGAN. In this case, the alternative example generation unit 102 generates an alternative example x_{G} for a certain correct answer label y_{G}. To be specific, for example, the alternative example generation unit 102 generates a random number r. Then, the alternative example generation unit 102 outputs a data point on the example generative model G by using the random number r. That is to say, the alternative example generation unit 102 sets G(r, y_{G})=x_{G}. Then, the alternative example generation unit 102 associates the generated alternative example with the correct answer label as (x_{G}, y_{G}).

The alternative example generation unit 102 can use a uniform random number, a normal random number that follows a normal distribution, or the like, as the random number.

The alternative example generation unit 102 repeats the abovementioned process of generating the alternative example x_{G} a predetermined number of times (N times). That is to say, the alternative example generation unit 102 repeats the abovementioned process of generating the alternative example x_{G} until a predetermined number N pairs of alternative examples x_{G} and correct answer labels y_{G} are obtained. At this time, the alternative example generation unit 102 may generate a predetermined number (same number) of alternative examples x_{G} for each correct answer label y_{G}, or may generate a different number of alternative examples x_{G} for each correct answer label y_{G}. For example, the alternative example generation unit 102 may generate N/L alternative examples x_{G} for each correct answer label y, where L is the total number of correct answer labels. By thus generating the alternative example x_{G} and correct answer label y_{G} pairs, the alternative example generation unit 102 obtains a set of alternative examples X_{G}=(x_{G1}, . . . , x_{GN}) and a set of correct answer labels Y_{G}=(y_{G1}, . . . , y_{GL}).

Herein, it is assumed that the alternative example x_{G} and the correct answer label y_{G} generated at the i(1<=i<=N)^{th} time can be obtained from X_{G} and Y_{G} as X_{G}[i] and YG[i] with i being an index, respectively. The predetermined number N may be a constant unique to the update device 100. Alternatively, the predetermined number N may be accepted as an input of the update device 100.

The adversarial example generation unit 104 generates an adversarial example X_{A} that induces misclassification in the pre-trained model C and a correction label Y_{A} for the adversarial example based on the attack model A having been input therein.

For example, the adversarial example generation unit 104 generates the adversarial example X_{A} and the correction label Y_{A} for the adversarial example based on the pre-trained model C, the alternative example and correct answer label pairs (X_{G}, Y_{G}) generated by the alternative example generation unit 102, and the attack model A. To be specific, the adversarial example generation unit 104 generates X_{A} and Y_{A} having M data points from the alternative example and correct answer label pairs (X_{G}, Y_{G}) by a method unique to the input attack model A, respectively. Herein, it is assumed that the j(1<=j<=M)^{th} adversarial example x_{A} and correction label y_{A} can be obtained as X_{A}[j], Y_{A}[j] from the adversarial example X_{A} and the correction label Y_{A} with j being an index.

Meanwhile, the adversarial example generation unit 104 may accept the example generative model G as an input instead of using the alternative example and correct answer label pairs (X_{G}, Y_{G}) generated by the alternative example generation unit 102. In this case, the adversarial example generation unit 104 may be configured to generate K alternative examples from the example generative model G in the same manner as the alternative example generation unit 102.

Here, as an example, an operation example in a case where Fast Gradient Sign Method (FGSM) is input as the attack model A into the adversarial example generation unit 104 is shown. In FGSM, the adversarial example x_{A} with a perturbation being given is generated from the alternative example x_{G} by calculation shown by Equation 1 below.

x_{A}=xx_{G}+ε Sign(∇ₓ_{_{G}}J(θ,x_{G},y_{G})) [Equation 1]

Herein, J(θ, x_, y_) is a loss function in classifying a data point x into a label y by using a neural network having a parameter θ, and ∇ₓJ(θ, x_, y_) is a gradient relating to x of the loss function. The function sign( ) is a sign function and returns +1 when the input is positive, −1 when the input is negative, and 0 when the input is 0. ε is a variable having a value of 0 or more and is a variable that adjusts the magnitude of a perturbation to be given. For example, a value such as 1.0 can be used for ε (a value other than the shown value may be used). Therefore, the equation shown by Equation 1 above outputs x_{A} with the perturbation described in the second term being given to the alternative example x_{G}.

FIG. 2 shows an example of the alternative example x_{G} and the corresponding adversarial example x_{A} by FGSM. As shown in FIG. 2, the adversarial example generation unit 104 perturbs the input alternative example x_{G} and outputs the adversarial example x_{A}. For example, in the case shown by FIG. 2, by perturbing a road sign that prohibits vehicle entry, which is the alternative example x_{G}, the adversarial example x_{A} having a checkered pattern is generated. Moreover, the adversarial example generation unit 104 sets the correct answer label y_{G} corresponding to the input alternative example x_{G} as the correction label y_{A}.

The correction label y_{A} may be determined by a method other than giving the same label as the correct answer label y_{G}. For example, the adversarial example generation unit 104 may obtain alternative examples that are k-nearest neighbors of the adversarial example x_{A}, and set the most frequent one of the correct answer labels given to the k alternative examples as the correction label y_{A}. Similarly, the adversarial example generation unit 104 may obtain alternative examples at a distance δ from the adversarial example x_{A}, and set the most frequent one of the correct answer labels given to the alternative examples as the correction label y_{A}.

The processing by the adversarial example generation unit 104 described above is merely an example. Instead of the FGSM, the adversarial example generation unit 104 may accept as an input a method of generating an AX such as Carlini-Wagner L2 Attack (CW Attack), Deepfool, or Iterative Gradient Sign Method as the attack model A. That is to say, the adversarial example generation unit 104 may operate the attack model A other than the FGSM to generate an adversarial example, and assign a correction label for correcting to a normal classification result to the adversarial example.

Further, the adversarial example generation unit 104 may be configured to generate an adversarial example and correction label pair for each of a plurality of attack models A of those exemplified above. In this case, the model update unit 106 to be described later performs additional learning with all the adversarial examples and correction labels corresponding to the respective attack models A being an input.

The model update unit 106 modifies the pre-trained model C so that it responds with a correction label when an adversarial example is input.

For example, the model update unit 106 performs training on the neural network π and parameter θ of the pre-trained model C with an alternative example and correct answer label pair (X_{G}, Y_{G}) and an adversarial example and correction label pair (X_{A}, Y_{A}) as training data X*={X_{G}, X_{A}}, Y*={Y_{G}, Y_{A}}. With this, the model update unit 106 obtains a new parameter θ* that has a higher probability of outputting the correction label Y_{A} than the pre-trained model C when the adversarial example X_{A} is input. As a result, the model update unit 106 generates an updated model C* having (π, θ*).

FIG. 3 is a view showing additional learning by the model update unit 106. As shown in FIG. 3, the model update unit 106 obtains an update parameter θ*, which is a new parameter, by performing additional training on the neural network it and parameter θ of the pre-trained model C.

As described above, there is a case where the adversarial example generation unit 104 generates an adversarial example X_{A} and correction label Y_{A} pair for each of a plurality of attack models A. In such a case, the model update unit 106 may perform additional learning including all the adversarial example X_{A} and correction label Y_{A} pairs at one time, or may perform training for each of the attack models and generate/update the updated model C*. For example, it is assumed that the adversarial example generation unit 104 generates an adversarial example X_{A} and correction label Y_{A} pair for a first attack model and also generates an adversarial example X_{A} and correction label Y_{A} pair for a second attack model. In this case, the model update unit 106 can generate the updated model C* by performing additional learning based on the adversarial example X_{A} and the correction label Y_{A} corresponding to the first attack model, and thereafter update the generated updated model C* by performing additional learning based on the adversarial example X_{A} and the correction label Y_{A} corresponding to the second attack model. The model update unit 106 may generate the updated model C* by performing additional learning based on the adversarial example X_{A} and the correction label Y_{A} corresponding to the first attack model and the adversarial example X_{A} and the correction label Y_{A} corresponding to the second attack model at one time.

When the model update unit 106 generates the updated model C* by performing additional learning based on the adversarial example X_{A} and the correction label Y_{A} corresponding to the first attack model and thereafter updates the generated updated model C* by performing additional learning based on the adversarial example X_{A} and the correction label Y_{A} corresponding to the second attack model, the effect of the additional learning already performed based on the adversarial example X_{A} and the correction label Y_{A} corresponding to the first attack model may be lost due to forgetting. In order to inhibit this forgetting, learning by optimization such as the Incremental Moment Matching method described in Non-Patent Document 2 may be used when the model update unit 106 generates the updated model C* by performing additional learning based on the adversarial example X_{A} and the correction label Y_{A} corresponding to the first attack model and thereafter updates the generated updated model C* by performing additional learning based on the adversarial example X_{A} and the correction label Y_{A} corresponding to the second attack model. After generating the updated model by performing additional learning corresponding to the first to K−1^{th} attack models, the model update unit 106 may generate the model C* by performing additional training based on the adversarial example X_{A} and the correction label Y_{A} corresponding to the K^{th} attack model by optimization that inhibits forgetting such as the Incremental Moment Matching method. Thus, the model update unit 106 may be configured to perform optimization for inhibiting forgetting when repeatedly performing additional learning.

The above is an example of the configuration of the update device 100. Subsequently, an example of an operation of the update device 100 will be described with reference to FIG. 4.

Referring to FIG. 4, the alternative example generation unit 102 of the update device 100 generates the alternative example X_{G} and the correct answer label Y_{G} for the alternative example X_{G} based on the example generative model G (step S101).

The adversarial example generation unit 104 generates the adversarial example X_{A} and the correction label Y_{A} of the adversarial example based on the alternative example and correct answer label pair (X_{G}, Y_{G}) generated by the alternative example generation unit 102 and the attack model A (step S102).

The model update unit 106 performs additional training on the neural network 7C and parameter θ of the pre-trained model C with the alternative example and correct answer label pair (X_{G}, Y_{G}) generated by the alternative example generation unit 102 and the adversarial example and correction label pair (X_{A}, Y_{A}) generated by the adversarial example generation unit 104 as training data X*={X_{G}, Y_{G}}, Y*={X_{A}, Y_{A}}. With this, the model update unit 106 obtains a new parameter θ* that has a higher probability of outputting the correction label Y_{A} than the pre-trained model C when the adversarial example X_{A} is input. As a result, the model update unit 106 generates the updated model C* having (π, θ*) (step S103).

Thus, the update device 100 in this example embodiment has the alternative example generation unit 102, the adversarial example generation unit 104, and the model update unit 106. With such a configuration, the alternative example generation unit 102 can generate the alternative example X_{G} and correct answer label Y_{G} pair based on the example generative model G. Moreover, the adversarial example generation unit 104 can generate the adversarial example X_{A} and correction label Y_{A} pair based on the attack model A. Then, the model update unit 106 can generate the updated model C* by performing additional learning based on the results generated by the alternative example generation unit 102 and the adversarial example generation unit 104. As a result, with the above configuration, it is possible to update a pre-trained model with forgetting being inhibited without using a normal example used when generating the pre-trained model C.

In other words, according to the present invention, it is possible to use the example generative model G representing normal examples instead of using normal examples used as training data when building the pre-trained model C, and update the parameter of the pre-trained model so that it responds with a class indicated by a correction label to an adversarial example while preventing forgetting of a classification task already acquired by the pre-trained model. With this, it becomes possible to decrease the size of data required for the update process and shorten a transmission time. The size of data of the example generative model G depends on the number of parameters. Therefore, when the number of parameters is large and the number of generated examples is very small, the example generative model G may be more redundant, and therefore the size thereof is not necessarily smaller than the size of normal examples. However, in many cases, the size of data is smaller when the example generative model G is used than when normal examples including many images, sounds and transactions are used.

Meanwhile, the configuration of the update device 100 is not limited to the abovementioned case. For example, the update device 100 can be configured to repeatedly update an updated model until a specified condition is satisfied.

For example, FIG. 5 shows an example of a configuration of an update device 110 that has the configuration as described above. Referring to FIG. 5, the update device 110 inputs the updated model C* as a pre-trained model again. Therefore, the adversarial example generation unit 104 newly generates the adversarial example X_{A} and the correction label Y_{A} by using the newly input updated model C*. Then, the model update unit 106 performs additional training on the updated model C* with the alternative example and correct answer label pair (X_{G}, Y_{G}) and the newly generated adversarial example and correction label pair (X_{A}, Y_{A}) as training data X*={X_{G}, X_{A}}, Y*={Y_{G}, Y_{A}}. Thus, the update device 110 is configured to update the updated model C* by using the adversarial example X_{A} and the correction label Y_{A} that are newly generated by the adversarial example generation unit 104 every time updating the updated model C*. In other words, the update device 110 can recursively repeat the update until a given condition determined in advance is satisfied.

Various conditions can be adopted for the update device 110 to stop updating the updated model C*. For example, the update device 110 can be configured to repeat the update of the updated model C* a predetermined number of times (the number of times can be set to any number). The update device 110 can also be configured to repeat the update of the updated model C* until the result of classification with a correction label as a classification result exceeds a given threshold value (may be any value) when an adversarial example is input. In a case where the update device 110 is configured as described above, the update device 110 may have a measurement unit that measures the accuracy of classification. The condition for the update device 110 to stop updating the updated model C* may be other than those illustrated above.

Further, as shown in FIG. 6, the model update unit 106 may be configured to input the updated trained model C* as the pre-trained model of the model update unit 106 again, and recursively repeat the update until a condition such as a given classification accuracy being achieved or repeated a given number of times is satisfied. That is to say, the present invention may be realized by an update device 120 having the model update unit 106 performing the processing as described above, instead of the update device 100 or the update device 110. Unlike the update device 110, the update device 120 shown in FIG. 6 does not generate the adversarial example X_{A} and the correction label Y_{A} for each update. That is to say, the model update unit 106 of the update device 120 repeats the update of the updated model C* using the same adversarial example X_{A} and the correction label Y_{A} until a given condition is satisfied.

### Second Example Embodiment

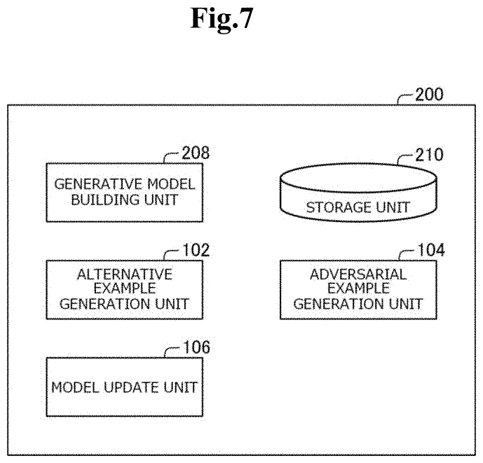

Next, a second example embodiment of the present invention will be described with reference to FIG. 7. FIG. 7 is a block diagram showing an example of a configuration of an update device 200.

In the second example embodiment of the present invention, the update device 200 as a modification example of the update device 100 will be described. A component included by the update device 200 to be described later may be applied to the respective modification examples described in the first example embodiment such as the update device 110 and the update device 120.

FIG. 7 shows an example of the configuration of the update device 200. Referring to FIG. 7, the update device 200 includes a generative model building unit 208 and a storage unit 210.

For example, the update device 200 includes a storage unit and an arithmetic logic unit, which are not shown in the drawings. The update device 200 realizes the abovementioned processing units by the arithmetic logic unit executing a program stored in the storage unit (not shown).

The generative model building unit 208 generates an example generative model G based on training data used in generating a pre-trained model C.

As an algorithm used when the generative model building unit 208 generates the example generation model G, a method of learning so as to express a generative model of training data corresponding to a training label with a small number of parameters, such as Conditional Generative Adversarial Networks (CGAN), a succeeding or developed form of CGAN like Auxiliary Classifier GAN (ACGAN), or Conditional Variational Auto Encoder (CVAE) can be used. Moreover, in a case where information about the distribution of training data corresponding to a training label is known, a probability density function representing the distribution may be used. Besides, in a case where it is known that training data corresponding to a training label is generated by a specific calculation formula, a generative model based on the calculation formula may be built.

The storage unit 210 is a storage unit such as a hard disk or a memory. In the storage unit 210, the example generative model G generated by the generative model building unit 208 is stored. In this example embodiment, the alternative example generation unit 102 generates an alternative example X_{G} and a correct answer label Y_{G} for the alternative example X_{G} based on the example generative model G stored in the storage unit 210.

Thus, the update device 200 includes the generative model building unit 208 and the storage unit 210. Such a configuration also makes it possible to update the parameter of a pre-trained model so that it responds with a class indicated by a correction label to an adversarial example while preventing the forgetting of a classification task already acquired by the pre-trained model without keeping holding a normal example, in the same manner as the update device 100 and the like described in the first example embodiment.

In this example embodiment, the update device 200 includes the generative model building unit 208 and the storage unit 210. However, the generative model building unit 208 and the storage unit 210 may not be necessarily included by the update device 200. For example, the present invention may be realized by using two or more information processing devices, for example, a compression device having a function as the generative model building unit 208 and the update device 100 (may be the update device 110 or the update device 120).

### <Hardware Configuration>

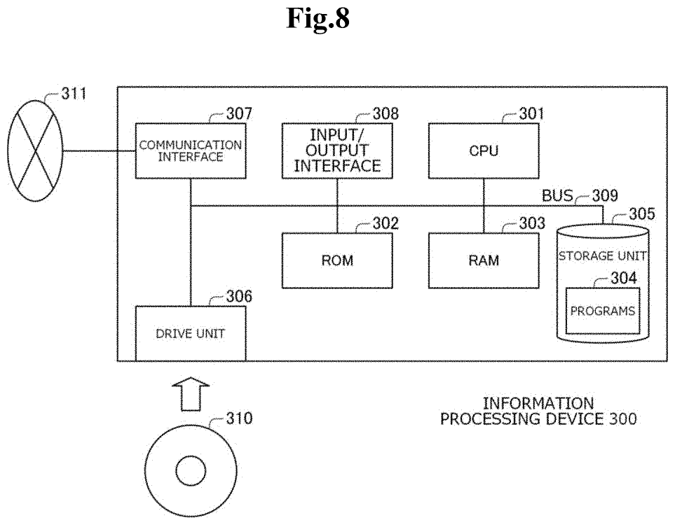

In the first and second example embodiments described above, each of the components included by the update device 100, the update device 110, the update device 120, and the update device 200 show a functional unit block. Some or all of the components included by the update device 100, the update device 110, the update device 120, and the update device 200 can be realized by any combination of an information processing device 300 and a program as shown in FIG. 8, for example. FIG. 8 is a block diagram showing an example of a hardware configuration of the information processing device 300 that realizes the respective components of the update device 100, the update device 110, the update device 120, and the update device 200. As an example, the information processing device 300 can include the following components:

CPU (Central Processing Unit) 301

ROM (Read Only Memory) 302

RAM (Random Access Memory) 303

Programs 304 loaded to the RAM 303

Storage unit 305 for storing the programs 304

Drive unit 306 reading from and writing to a storage medium 310 installed outside the information processing device 300

Communication interface 307 connected to a communication network 311 installed outside the information processing device 300

Input/output interface 308 inputting and outputting data

Bus 309 connecting the components.

The respective components included by the update device 100, the update device 110, the update device 120, and the update device 200 in the example embodiments described above can be realized by the CPU 301 acquiring and executing the programs 304 realizing the functions of the respective components. For example, the programs 304 realizing the functions of the respective components included by the update device 100, the update device 110, the update device 120, and the update device 200 are stored in the storage unit 305 or the ROM 302 in advance, and the CPU 301 loads to the RAM 303 and executes when necessary. The programs 304 may be supplied to the CPU 301 via the communication network 311. Alternatively, the programs 304 may be stored in the recording medium 310 in advance, and the drive unit 306 may read the programs and supply to the CPU 301.

FIG. 8 shows an example of a configuration of the information processing device 300, and the configuration of the information processing device 300 is not exemplified in the abovementioned case. For example, the information processing device 300 may be configured by part of the abovementioned configuration. For example, the information processing device 300 may not include the drive unit 306.

### Third Example Embodiment

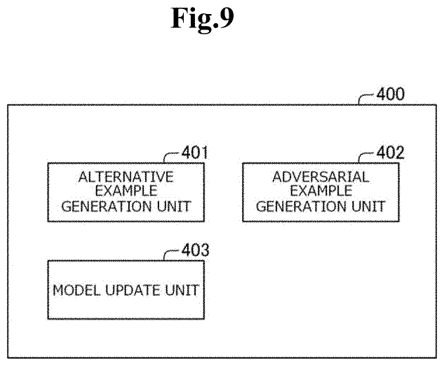

Next, a third example embodiment of the present invention will be described with reference to FIG. 9. In the third example embodiment, the overview of a configuration of a pre-trained model update device 400 will be described.

FIG. 9 shows an example of the configuration of the pre-trained model update device 400. Referring to FIG. 9, the pre-trained model update device 400 includes an alternative example generation unit 401, an adversarial example generation unit 402, and a model update unit 403.

The alternative example generation unit 401 generates an alternative example and a correct answer label corresponding to the alternative example based on a generative model representing training data used at the time of generating a pre-trained model.

The adversarial example generation unit 402 generates an adversarial example inducing the pre-trained model to misclassify and a correction label corresponding to the adversarial example, based on an attack model and based on the alternative example and the correct answer label that are generated by the alternative example generation unit 401.

The model update unit 403 generates an updated model by performing additional learning based on the result of generation by the alternative example generation unit 401 and the result of generation by the adversarial example generation unit 402.

Thus, the pre-trained model update device 400 in this example embodiment includes the alternative example generation unit 401, the adversarial example generation unit 402, and the model update unit 403. With such a configuration, the alternative example generation unit 401 can generate an alternative example and correct answer label pair based on a generative model. Moreover, the adversarial example generation unit 402 can generate an adversarial example and correction label pair based on an attack model. Then, the model update unit 403 can generate an updated model by performing additional learning based on the results of generation by the alternative example generation unit 401 and the adversarial example generation unit 402. As a result, the above configuration makes it possible to update a pre-trained model with forgetting being inhibited without using a normal example used at the time of generating a pre-trained model.

Further, the abovementioned pre-trained model update device 400 can be realized by a given program being installed in the pre-trained model update device 400. To be specific, a program according to another aspect of the present invention is a program for causing a pre-trained model update device to realize: an alternative example generation unit configured to generate an alternative example and a correct answer label corresponding to the alternative example based on a generative model representing training data used at the time of generating a pre-trained model; an adversarial example generation unit configured to generate an adversarial example inducing the pre-trained model to misclassify and a correction label corresponding to the adversarial example based on an attack model and based on the alternative example and the correct answer label that are generated by the alternative example generation unit; and a model update unit configured to generate an updated model by performing additional learning based on a result of generation by the alternative example generation unit and a result of generation by the adversarial example generation unit.

Further, a pre-trained model update method executed by the abovementioned pre-trained model update device 400 is a method by which the pre-trained model update device: generates an alternative example and a correct answer label corresponding to the alternative example based on a generative model representing training data used at the time of generating a pre-trained model; generates an adversarial example inducing the pre-trained model to misclassify and a correction label corresponding to the adversarial example based on an attack model and based on the alternative example and the correct answer label that have been generated; and generates an updated model by performing additional learning based on the alternative example and the correct answer label and based on the adversarial example and the correction label.

The invention of the program or the pre-trained model update method with the abovementioned configuration has the same action as the pre-trained model update device 400, and therefore, can achieve the object of the present invention.

### <Supplementary Notes>

The whole or part of the exemplary embodiments disclosed above can be described as the following supplementary notes. Below, the overview of a pre-trained model update device and so on in the present invention will be described. However, the present invention is not limited to the following configurations.

### (Supplementary Note 1)

A pre-trained model update device comprising:

an alternative example generation unit configured to generate an alternative example and a correct answer label corresponding to the alternative example, based on a generative model representing training data used in generating a pre-trained model;

an adversarial example generation unit configured to generate an adversarial example inducing the pre-trained model to misclassify and a correction label corresponding to the adversarial example, based on an attack model and based on the alternative example and the correct answer label generated by the alternative example generation unit; and

a model update unit configured to perform additional learning based on a result of generation by the alternative example generation unit and a result of generation by the adversarial example generation unit, and generate an updated model.

### (Supplementary Note 2)

The pre-trained model update device according to Supplementary Note 1, further comprising:

a generative model building unit configured to generate the generative model based on the training data used in generating the pre-trained model; and

a storage unit configured to have the generative model built by the generative model building unit stored therein,

wherein the alternative example generation unit is configured to generate the alternative example and the correct answer label corresponding to the alternative example, based on the generative model stored in the storage unit.

### (Supplementary Note 3)

The pre-trained model update device according to Supplementary Note 2, wherein the generative model building unit is configured to use Conditional Generative Adversarial Networks when generating the generative model corresponding to the training data.

### (Supplementary Note 4)

The pre-trained model update device according to Supplementary Note 2, wherein the generative model building unit is configured to use Conditional Variational Auto Encoder when generating the generative model corresponding to the training data.

### (Supplementary Note 5)

The pre-trained model update device according to any one of Supplementary Notes 1 to 4, wherein the model update unit is configured to repeatedly update the updated model generated by the model update unit until a given condition is satisfied.

### (Supplementary Note 6)

The pre-trained model update device according to Supplementary Note 5, wherein the model update unit is configured to update the updated model by using the adversarial example and the correction label that are newly generated by the adversarial example generation unit every time updating the updated model.

### (Supplementary Note 7)

The pre-trained model update device according to Supplementary Note 5, wherein the model update unit is configured to repeatedly update the updated model until a given condition is satisfied by using the same adversarial example and the same correction label.

### (Supplementary Note 8)

The pre-trained model update device according to any one of Supplementary Notes 5 to 7, wherein the model update unit is configured to repeatedly update the updated model generated by the model update unit a previously determined given number of times.

### (Supplementary Note 9)

The pre-trained model update device according to any one of Supplementary Notes 5 to 8, wherein the model update unit is configured to repeatedly update the updated model until accuracy of classification in which the correction label is a classification result for the adversarial example exceeds a given threshold value.

### (Supplementary Note 10)

The pre-trained model update device according to any one of Supplementary Notes 1 to 9, wherein the adversarial example generation unit is configured to generate the adversarial example and the correction label that correspond to each of a plurality of attack models.

### (Supplementary Note 11)

The pre-trained model update device according to Supplementary Note 9, wherein the model update unit is configured to, after performing additional learning based on the adversarial example and the correction label that correspond to a first attack model and generating the updated model, perform additional learning based on the adversarial example and the correction label that correspond to a second attack model and update the generated updated model.

### (Supplementary Note 12)

A pre-trained model update method executed by a pre-trained model update device, the pre-trained model update method comprising:

generating an alternative example and a correct answer label corresponding to the alternative example, based on a generative model representing training data used in generating a pre-trained model;

generating an adversarial example inducing the pre-trained model to misclassify and a correction label corresponding to the adversarial example, based on an attack model and based on the alternative example and the correct answer label generated by the alternative example generation unit; and

performing additional learning based on the alternative example and the correct answer label and based on the adversarial example and the correction label, and generating an updated model.

### (Supplementary Note 13)

A computer program comprising instructions for causing a pre-trained model update device to realize:

an alternative example generation unit configured to generate an alternative example and a correct answer label corresponding to the alternative example, based on a generative model representing training data used in generating a pre-trained model;

an adversarial example generation unit configured to generate an adversarial example inducing the pre-trained model to misclassify and a correction label corresponding to the adversarial example, based on an attack model and based on the alternative example and the correct answer label generated by the alternative example generation unit; and

a model update unit configured to perform additional learning based on a result of generation by the alternative example generation unit and a result of generation by the adversarial example generation unit, and generate an updated model.

The program described in the example embodiments and supplementary notes is stored in a storage unit or recorded on a computer-readable recording medium. For example, the recording medium is a portable medium such as a flexible disk, an optical disk, a magnetooptical disk, and a semiconductor memory.

Although the present invention has been described above with reference to the example embodiments, the present invention is not limited to the example embodiments. The configurations and details of the present invention can be changed in various manners that can be understood by one skilled in the art within the scope of the present invention.

### DESCRIPTION OF NUMERALS

100 update device
102 alternative example generation unit
104 adversarial example generation unit
106 model update unit
110 update device
120 update device
200 update device
208 generative model building unit
210 storage unit
300 information processing device
301 CPU
302 ROM
303 RAM
304 programs
305 storage unit
306 drive unit
307 communication interface
308 input/output interface
309 bus
310 recording medium
311 communication network

What is claimed is:

1. A pre-trained model update device comprising:
an alternative example generation unit configured to generate an alternative example and a correct answer label corresponding to the alternative example, based on a generative model representing training data used in generating a pre-trained model;
an adversarial example generation unit configured to generate an adversarial example inducing the pre-trained model to misclassify and a correction label corresponding to the adversarial example, based on an attack model and based on the alternative example and the correct answer label generated by the alternative example generation unit; and
a model update unit configured to perform additional learning based on a result of generation by the alternative example generation unit and a result of generation by the adversarial example generation unit, and generate an updated model.

2. The pre-trained model update device according to claim 1, further comprising:
a generative model building unit configured to generate the generative model based on the training data used in generating the pre-trained model; and
a storage unit configured to have the generative model built by the generative model building unit stored therein,
wherein the alternative example generation unit is configured to generate the alternative example and the correct answer label corresponding to the alternative example, based on the generative model stored in the storage unit.

3. The pre-trained model update device according to claim 2, wherein the generative model building unit is configured to use Conditional Generative Adversarial Networks when generating the generative model corresponding to the training data.

4. The pre-trained model update device according to claim 2, wherein the generative model building unit is configured to use Conditional Variational Auto Encoder when generating the generative model corresponding to the training data.

5. The pre-trained model update device according to claim 1, wherein the model update unit is configured to repeatedly update the updated model generated by the model update unit until a given condition is satisfied.

6. The pre-trained model update device according to claim 5, wherein the model update unit is configured to update the updated model by using the adversarial example and the correction label that are newly generated by the adversarial example generation unit every time updating the updated model.

7. The pre-trained model update device according to claim 5, wherein the model update unit is configured to repeatedly update the updated model until a given condition is satisfied by using the same adversarial example and the same correction label.

8. The pre-trained model update device according to claim 5, wherein the model update unit is configured to repeatedly update the updated model generated by the model update unit a previously determined given number of times.

9. The pre-trained model update device according to claim 5, wherein the model update unit is configured to repeatedly update the updated model until accuracy of classification in which the correction label is a classification result for the adversarial example exceeds a given threshold value.

10. The pre-trained model update device according to claim 1, wherein the adversarial example generation unit is configured to generate the adversarial example and the correction label that correspond to each of a plurality of attack models.

11. The pre-trained model update device according to claim 9, wherein the model update unit is configured to, after performing additional learning based on the adversarial example and the correction label that correspond to a first attack model and generating the updated model, perform additional learning based on the adversarial example and the correction label that correspond to a second attack model and update the generated updated model.

12. A pre-trained model update method executed by a pre-trained model update device, the pre-trained model update method comprising:
generating an alternative example and a correct answer label corresponding to the alternative example, based on a generative model representing training data used in generating a pre-trained model;
generating an adversarial example inducing the pre-trained model to misclassify and a correction label corresponding to the adversarial example, based on an attack model and based on the alternative example and the correct answer label generated by the alternative example generation unit; and
performing additional learning based on the alternative example and the correct answer label and based on the adversarial example and the correction label, and generating an updated model.

13. A non-transitory computer-readable recording medium having a computer program recorded thereon, the computer program comprising instructions for causing a pre-trained model update device to realize:
an alternative example generation unit configured to generate an alternative example and a correct answer label corresponding to the alternative example, based on a generative model representing training data used in generating a pre-trained model;
an adversarial example generation unit configured to generate an adversarial example inducing the pre-trained model to misclassify and a correction label corresponding to the adversarial example, based on an attack model and based on the alternative example and the correct answer label generated by the alternative example generation unit; and
a model update unit configured to perform additional learning based on a result of generation by the alternative example generation unit and a result of generation by the adversarial example generation unit, and generate an updated model.
